(19) United States
(12) Patent Application Publication
(10) Pub. No.: US 2020/0211380 A1
(43) Pub. Date: Jul. 2, 2020

(54) SYNERGISTIC TRAFFIC INTERSECTION

(71) Applicant: Valiant Yuk Yuen Leung, Narwee, New South Wales (AU)

(72) Inventor: Valiant Yuk Yuen Leung, Narwee, New South Wales (AU)

(21) Appl. No.: 16/304,654

(22) PCT Filed: May 18, 2017
(86) PCT No.: PCT/AU2017/050465

§ 371 Date: Nov. 26, 2018

(30) Foreign Application Priority Data
May 19, 2016 (AU) 2016901871

(51) Int. Cl. G08G 1/081; G08G 1/095; G08G 1/01; G08G 1/005; E01C 1/02

(52) U.S. Cl. CPC G08G 1/081; G08G 1/095; E01C 1/02; G08G 1/0145; G08G 1/005; G08G 1/0141

(57) ABSTRACT

The present invention provides a traffic intersection located at an intersection of two multilane roads, each road comprising a plurality of traffic lanes spaced adjacent each other, the traffic intersection comprising an intersection region wherein the surface area of the intersecting roads overlap, a proximate region in which each road approaching the intersection defines at least one turning right lane for guiding vehicles to turn right at the intersection onto the intersecting road, at least one going straight lane for guiding vehicles to move straight through the intersection on the same road and at least one going straight receiving lane for receiving vehicles moving straight through the intersection.

### FIELD OF THE INVENTION

The present invention relates to a traffic intersection, a system for directing traffic and a method therefor.

The invention has been developed primarily for use in/with regard to traffic intersections and traffic flow on congested roads, and will be described hereinafter with reference to this application. However, it will be appreciated that the invention is not limited to this particular field of use.

### BACKGROUND OF THE INVENTION

Increasingly large cities worldwide have led to increased traffic congestion. Larger roads are being designed and created, with more lanes to them, to handle increasingly larger numbers of vehicles.

However, where such larger roads intersect, each with many lanes, the flow of traffic can be interrupted by a long waiting period attraffic lights. This is typically caused by the cars having to wait for all the various combinations and permutations of signals to be processed for cars approaching from different sides, and that are turning in various different directions or proceeding straight.

These long waiting periods may create additional congestion on busy roads.

Further, large volumes of pedestrian traffic can create congestion at large intersections where the pedestrian traffic needs to cross over the intersection.

It is to be understood that, if any prior art information is referred to herein, such reference does not constitute an admission that the information forms part of the common general knowledge in the art, in Australia or any other country.

### SUMMARY OF THE INVENTION

The invention seeks to provide a traffic intersection, a system for directing traffic and a method therefor, which will overcome or substantially ameliorate at least some of the deficiencies of the prior art, or to at least provide an alternative.

(For left-side drive roads) According to a first aspect of the present invention, the invention may be said to broadly consist in a traffic intersection located at an intersection of two multilane roads, each road comprising a plurality of traffic lanes spaced adjacent each other, the traffic intersection comprising:

a) an intersection region wherein the surface area of the intersecting roads overlap;

b) a proximate region in which each road approaching the intersection defines:
i) at least one turning right lane for guiding vehicles to turn right at the intersection onto the intersecting road;
ii) at least one going straight lane for guiding vehicles to move straight through the intersection on the same road; and
iii) at least one going straight receiving lane for receiving vehicles moving straight through the intersection;

c) wherein the turning right lane is configured to split from the going straight lane in the proximate region by crossing through a distal crossover zone, so that vehicles travelling straight through the intersection in an opposite direction along the same road are guided to move between the turning right lane and the going straight lane in the going straight receiving lane; and

d) wherein the going straight lanes are configured for guiding vehicles over the intersection to at least one or more going straight receiving lanes at an opposed side of the intersection; and

e) wherein the turning right lane is configured for guiding vehicles to turn from the turning right lane of one of the intersecting roads into a receiving straight lane on the other of the intersecting roads.

In one embodiment the going straight lanes are configured for guiding vehicles over the intersection in a straight line to the said at least one or more going straight receiving lanes.

In one embodiment, the proximate region further comprises at least one or more turning left lanes configured for guiding vehicles to turn left at the intersection onto the intersecting road.

In one embodiment, the turning left lane is configured for guiding vehicles to turn from the turning left lane of one of the intersecting road into a going straight receiving lane on the other of the intersecting roads.

In one embodiment, at least one or more selected from the turning left lane and the going straight lanes are configured to terminate in a staggered fashion adjacent the intersection region to thereby allow space for a proximal crossover zone.

In one embodiment, at least one of the intersecting roads comprises a plurality of going straight lanes that terminate in a staggered fashion adjacent the intersection region, to thereby allow space for the proximal crossover zone, the proximal crossover zone being configured for allowing vehicles turning from a turning right lane in the intersecting road to take a variety of pathing routes in order to avoid pedestrians that are crossing the road that the proximal crossover zone is in.

In one embodiment, the proximate region defines a combination turning left and proximal crossover zone is disposed adjacent a combination turning left and going straight lane, and is configured to receive vehicles that are moving straight through the intersection, thereby allowing the vehicles moving straight through the intersection to pass vehicles that are turning left from the combination turning left and going straight lane.

In one embodiment, the road with the proximal crossover zone is a four-lane road.

In one embodiment, in the proximate region of the four-lane road, the road defines a combination turning left and going straight lane, a going straight receiving lane and a turning right lane, wherein the turning right lane is disposed two lane widths apart from the combination turning left and going straight lane, and the proximal crossover zone is disposed adjacent the combination turning left and going straight lane, and is configured to receive vehicles that are moving straight through the intersection, thereby allowing the vehicles moving straight through the intersection to pass vehicles that are turning left from the combination turning left and going straight lane.

In one embodiment, the distal crossover zone is configured for guiding vehicles to do a U-turn.

In one embodiment, at least one intersecting road defines a right turning lane distal of the distal crossover zone, and is configured for guiding vehicles to give way to vehicles crossing over the distal crossover zone from the at least one or more going straight receiving lanes.

In one embodiment, at least one or more selected from the turning left lanes and the going straight lanes are configured to terminate in a staggered fashion adjacent the intersection region to thereby allow space for the proximal crossover zone.

In one embodiment, the proximal crossover zone is configured substantially triangularly.

In one embodiment, the proximal crossover zone is configured for allowing vehicles turning from a turning right lane in the intersecting road to take a variety of pathing routes in order to avoid pedestrians that are crossing the road that the proximal crossover zone is in.

In one embodiment, each of the going straight receiving lanes is configured to guide vehicles to the distal crossover zone, to allow vehicles moving straight through the intersection region to cross the distal crossover zone.

In one embodiment, the going straight lane in the proximate region is also configured as a turning left lane for guiding vehicles to turn left at the intersection region onto the intersecting road.

In one embodiment, the traffic intersection comprises visual signalling devices configured for safely directing vehicles on the roads through the intersection region.

In one embodiment, the visual signalling devices are operable in one of two modes of operation.

In one embodiment, the visual signalling devices are operable in a go condition and a stop condition.

In one embodiment, the visual signalling devices are operable in a go condition, a stop condition and a slow condition.

In one embodiment, the visual signalling devices of the entire intersection are operable in two configurations.

In one embodiment, the visual signalling devices of the entire intersection are operable in three configurations.

In one embodiment, the visual signalling devices are configured for safely directing pedestrians across at least one of the roads at the proximate region.

In one embodiment, the proximate region further comprises at least one turning receiving lane configured for receiving and guiding one or both selected from

f) vehicles turning right from the intersecting road; and

g) vehicles turning left from the intersecting road.

In one embodiment the proximate region comprises a plurality of turning receiving lanes.

In one embodiment, the turning right lane is configured to diverge from the other lanes in the proximate region by crossing through the distal crossover zone so that going straight receiving lanes for guiding vehicles moving straight across the intersection from the opposing side extends between the turning right lane and the going straight lane.

In one embodiment, the traffic intersection comprises an intermediate visual signalling arrangement configured for visually signalling one or more selected from a vehicle and a bicycle in the proximate region approaching the distal crossover zone.

In one embodiment, the intermediate visual signalling arrangement is one or more selected from road marking and a signalling device.

In one embodiment, the signalling device is a traffic light.

In one embodiment, the traffic intersection comprises a plurality of bicycle lanes.

In one embodiment, the bicycle lanes are configured for extending along at least one of the roads adjacent the side of the road.

In one embodiment, the traffic intersection defines pedestrian crossings configured for guiding pedestrians across at least one of the intersecting roads.

In one embodiment, the traffic intersection defines bicycle crossings configured for guiding bicycles across at least one of the intersecting roads.

In one embodiment, the bicycle crossings located adjacent the pedestrian crossings.

In one embodiment, the traffic intersection comprises visual signalling arrangements configured for signalling to bicycles crossing at the bicycle crossings.

In one embodiment, the distal crossover zone is distal to the intersection region and the proximal crossover zone is more proximate to the intersection region.

In one embodiment, the traffic intersection comprises at least one or more intermediate lanes extending between the distal crossover zone and the proximal crossover zone.

In one embodiment, the visual signalling arrangements are devices.

In one embodiment, the visual signalling arrangements traffic lights.

In one embodiment, the traffic intersection comprises one or more bus stop bays located adjacent the distal crossover zone.

According to another aspect, the invention may be said to broadly consist in a traffic intersection located at an intersection of two multilane roads, each road comprising a plurality of traffic lanes spaced adjacent each other, the traffic intersection comprising:
a. an intersection region wherein the surface area of the intersecting roads overlap;
b. a proximate region in which at least one of the roads approaching the intersection defines:
   i. at least one turning right lane for guiding vehicles to turn right at the intersection onto the intersecting road;
   ii. at least one combination going straight and turning left lane for guiding vehicles to move straight through the intersection and to turn left at the intersection;
c. wherein the turning right lane is configured to split from the going straight lane in the proximate region by crossing through a distal crossover zone, so that vehicles travelling straight through the intersection in an opposite direction along the same road are guided to move in an opposed direction between the turning right lane and the combination going straight and turning left lane in a going straight receiving lane; and
d. wherein the traffic intersection defines a proximal crossover zone disposed adjacent the combination turning left and going straight lane, and is configured to receive vehicles that are moving straight through the intersection, thereby allowing the vehicles moving straight through the intersection to pass vehicles that are turning left from the combination turning left and going straight lane.

In one embodiment, the road with the proximal crossover zone is a four-lane road.

In one embodiment, in the proximate region of the four-lane road, the road defines a combination turning left and going straight lane, a going straight receiving lane and a turning right lane, wherein the turning right lane is disposed two lane widths apart from the combination turning left and going straight lane, and the proximal crossover zone is disposed adjacent the combination turning left and going straight lane, and is configured to receive vehicles that are moving straight through the intersection, thereby allowing the vehicles moving straight through the intersection to pass vehicles that are turning left from the combination turning left and going straight lane.

In one embodiment, at least one or more selected from the turning left lanes and the going straight lanes are configured to terminate in a staggered fashion adjacent the intersection region to thereby allow space for the proximal crossover zone.

In one embodiment, at least one of the intersecting roads comprises a plurality of going straight lanes that terminate in a staggered fashion adjacent the intersection region, to thereby allow space for a proximal crossover zone, the proximal crossover zone being configured for allowing vehicles turning from a turning right lane in the intersecting road to take a variety of pathing routes in order to avoid pedestrians that are crossing the road that the proximal crossover zone is in.

In one embodiment, the proximate region defines at least one turning right lane for guiding vehicles to turn right at the intersection onto the intersecting road and wherein the turning right lane is configured for guiding vehicles to turn from the turning right lane of one of the intersecting roads into a receiving straight lane on the other of the intersecting roads.

In one embodiment, the traffic intersection comprises one or more bus stop bays located adjacent the distal crossover zone.

According to another aspect, the invention may be said to consist in a traffic intersection located at an intersection of two multilane roads, each road comprising a plurality of traffic lanes spaced adjacent each other, the traffic intersection comprising:
a. an intersection region wherein the surface area of the intersecting roads overlap;
b. a proximate region in which each road approaching the intersection defines:
   i. at least one turning right lane for guiding vehicles to turn right at the intersection onto the intersecting road;
   ii. at least one turning left lane configured for guiding vehicles to turn left at the intersection onto the intersecting road;
   iii. a plurality of going straight lane for guiding vehicles to move straight through the intersection on the same road;
c. wherein the turning right lane is configured to split from the going straight lane in the proximate region by crossing through a distal crossover zone, so that vehicles travelling straight through the intersection in an opposite direction along the same road are guided to move between the turning right lane and the going straight lane; and
d. wherein the plurality of going straight lanes terminate in a staggered fashion adjacent the intersection region, and to thereby allow space for a proximal crossover zone, the proximal crossover zone being configured for allowing vehicles turning from a turning right lane in the intersecting road to take a variety of pathing routes in order to avoid pedestrians that are crossing the road that the proximal crossover zone is in.

In one embodiment, the turning right lane is configured for guiding vehicles to turn from the turning right lane of one of the intersecting roads into a receiving straight lane on the other of the intersecting roads.

In one embodiment, the turning right lane is configured to split from the going straight lane in the proximate region by crossing through a distal crossover zone, so that vehicles travelling straight through the intersection in an opposite direction along the same road are guided to move between the turning right lane and the going straight lane.

In one embodiment, the proximal crossover zone is configured to receive vehicles that are moving straight through the intersection, from the turning left lane thereby allowing the vehicles moving straight through the intersection to pass vehicles that are turning left from the combination turning left and going straight lane.

In one embodiment, the traffic intersection defines a proximal crossover zone disposed adjacent the combination turning left and going straight lane, and is configured to receive vehicles that are moving straight through the intersection, thereby allowing the vehicles moving straight through the intersection to pass vehicles that are turning left from the combination turning left and going straight lane.

In one embodiment, the road with the proximal crossover zone is a four-lane road.

In one embodiment, in the proximate region of the four-lane road, the road defines a combination turning left and going straight lane, a going straight receiving lane and a turning right lane, wherein the turning right lane is disposed two lane widths apart from the combination turning left and going straight lane, and the proximal crossover zone is disposed adjacent the combination turning left and going straight lane, and is configured to receive vehicles that are moving straight through the intersection, thereby allowing the vehicles moving straight through the intersection to pass vehicles that are turning left from the combination turning left and going straight lane.

In one embodiment, the traffic intersection comprises one or more bus stop bays located adjacent the distal crossover zone.

According to another aspect, the invention may be said to broadly consist in a traffic guidance system for deployment at a traffic intersection as described above, the traffic guidance system comprising
a. at least one or more visual signalling devices configured for displaying guidance signals to vehicles on both intersecting roads, including displaying guidance signals to vehicles turning across the flow of oncoming traffic;
b. a control system configured for controlling operation of the visual signalling devices in one of two configurations to thereby guide vehicles to move safely across the intersection.

In one embodiment, the control system is configured for controlling operation of the visual signalling devices in one of two configurations.

In one embodiment, the two configurations are one or more selected from:
a. a configuration wherein all vehicles along one of the intersecting roads are signalled to move straight across the intersection and to turn from the road that they are on, onto the intersecting road;
b. a configuration wherein all vehicles moving along both of the intersecting roads are stopped, and one or more selected from pedestrians and bicycles are signalled to cross the intersecting roads.

In one embodiment, the traffic intersection comprises one or more bus stop bays located adjacent the distal crossover zone.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a schematic view of a traffic intersection of a six lane road with a six lane road, with vehicles moving in both directions on each road with the visual signalling devices being in a first configuration;

FIG. 2 shows a schematic view of the first embodiment of a traffic intersection of a six lane road with a six lane road, with vehicles moving in both directions on each road with the visual signalling devices being in a second configuration;

FIG. 3 shows a schematic view of a second embodiment of a traffic intersection of a four lane road with a four lane road, with vehicles moving in both directions on each road with the visual signalling devices being in a first configuration;

FIG. 4 shows a schematic view of a second embodiment of a traffic intersection of a four lane road with a four lane road, with vehicles moving in both directions on each road with the visual signalling devices being in a second configuration for pedestrians to cross;

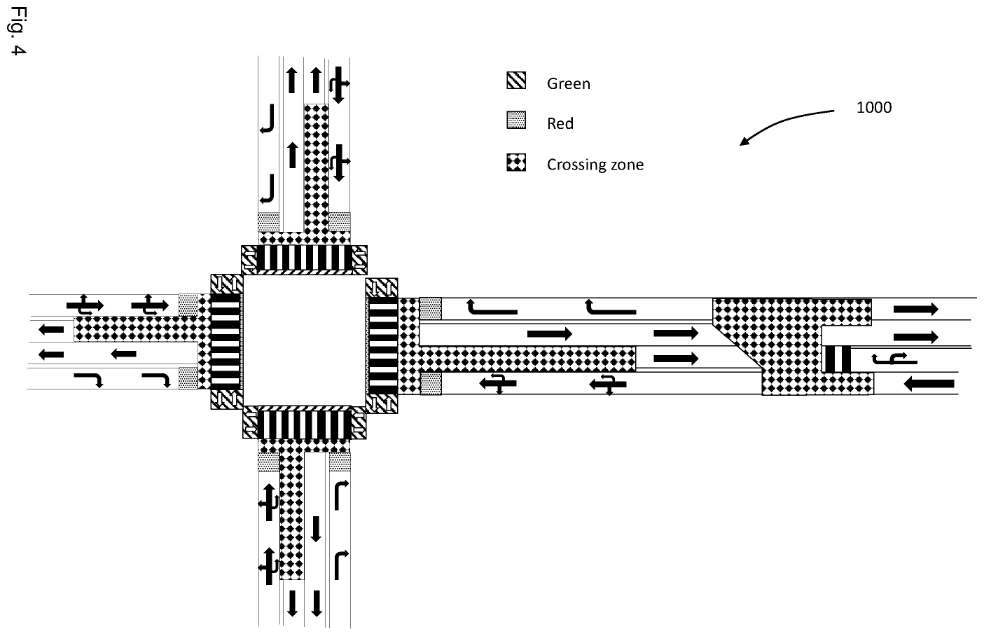

FIG. 5 shows a schematic view of a third embodiment of a traffic intersection of a six lane road with a four lane road, with vehicles moving in both directions on each road, and with the visual signalling devices being in a first configuration;

FIG. 6 shows a schematic view of a fourth embodiment of a traffic intersection of a four lane road with a two lane road, with vehicles moving in both directions on each road, and with the visual signalling devices being in a first configuration;

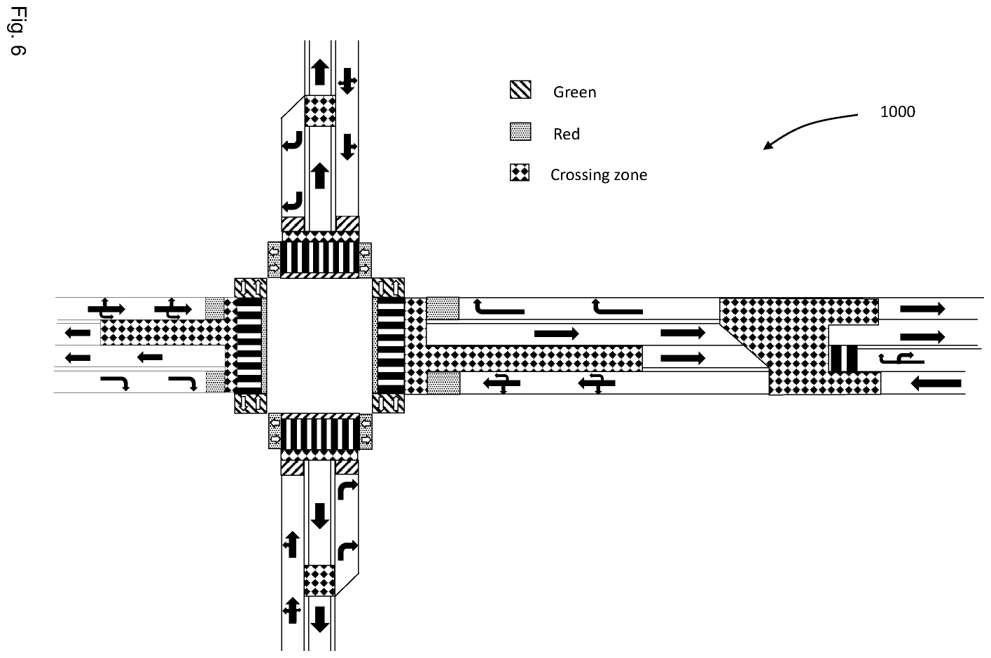

FIG. 7 shows a schematic view of a fifth embodiment of a traffic intersection of a four lane road with a three lane road, with vehicles moving in both directions on each road, and with the visual signalling devices being in a first configuration;

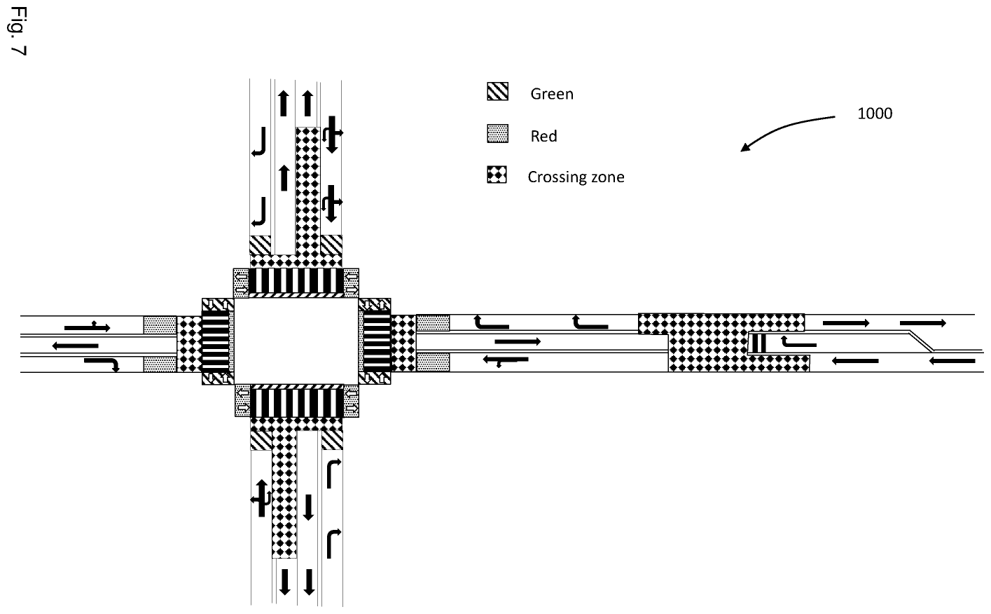

FIG. 8 shows a schematic view of a sixth embodiment of a traffic intersection of a six lane road with a three lane road, with vehicles moving in both directions on each road, and with the visual signalling devices being in a first configuration;

FIG. 9 shows a schematic view of a seventh embodiment of a traffic intersection of a six lane road with a two lane road, with vehicles moving in both directions on each road, and with the visual signalling devices being in a first configuration;

FIG. 10 shows a schematic view of an eighth embodiment of a traffic intersection of a ten lane road with a six lane road, with vehicles moving in both directions on each road, and with the visual signalling devices being in a first configuration;

FIG. 11 shows a close-up schematic view of an eighth embodiment of a traffic intersection of FIG. 10, illustrating the various pathing options that vehicles turning into the intersecting road have to move past pedestrians;

FIG. 12 shows a schematic view of a ninth embodiment of a traffic intersection of a six lane road with a three lane road including bicycle paths and bicycle crossings;

FIG. 13 shows a schematic view of a first embodiment of a traffic intersection shown in FIG. 1, with the visual signalling devices in a third configuration;

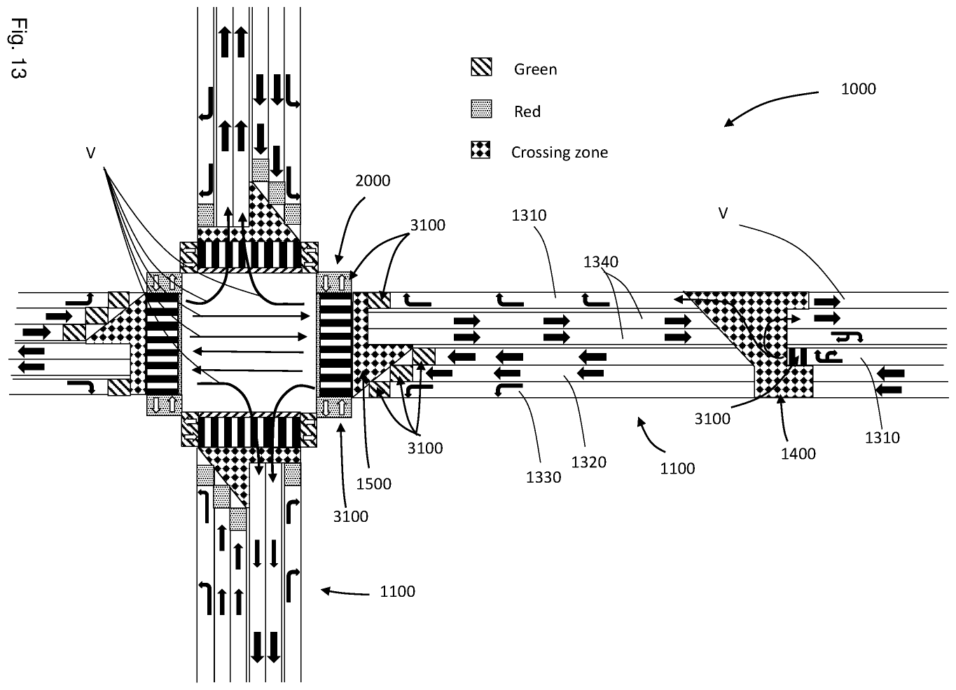

FIG. 14 shows a schematic view of a distal crossover zone on a six lane road with bus stops disposed to either side of the distal crossover zone;

FIG. 15 shows a schematic view of four traffic intersections configured to guide traffic to and from each other;

FIG. 16 shows a schematic view of a distal crossover zone on a three lane road with bus stops disposed to either side of the distal crossover zone;

FIG. 17 shows a schematic view of a proximate region with a distal crossover zone on a four lane road with bus stops disposed to either side of the distal crossover zone; and

FIG. 18 shows a close up schematic view of an intersection region and proximate regions showing pedestrian crossings that have been marked to display street numbers.

### DESCRIPTION OF EMBODIMENTS

It should be noted in the following description that like or the same reference numerals in different embodiments denote the same or similar features.

### Traffic Intersection

For the purposes of explanation of the present invention, the intersections and traffic guidance systems of the present invention will be described with reference to road laws requiring vehicles to drive on the left hand side of the road. However, it will be appreciated that the invention may be carried out as effectively on intersections and using traffic guidance systems operational in countries where vehicles drive on the right-hand side of the road by interchanging any reference to the word ‘right_with the word ‘left_, and any reference to the word left_ with the word ‘right_, and by mirroring the figures shown.

In one embodiment now described, there is provided a traffic intersection 1000. The traffic intersection 1000 is located at an intersection of two multilane roads 1100. Each road comprises a plurality of traffic lanes as will be described in more detail below. Each traffic lane is spaced adjacent each other, possibly allowing for safety barriers and/or pedestrian islands between them.

The traffic intersection 1000 comprises an intersection region 1200 where the surface area of the intersecting roads substantially overlap, and proximate region 1300 that is located proximate the intersection region 1200. The proximate region 1300 includes a turning right lane 1310 for guiding vehicles to turn right at the intersection on to the intersecting road 1100. The proximate region 1300 further includes a going straight lane 1320 for guiding vehicles to move straight through the intersection on the same road 1100. Only these two lanes would be required for an intersection of a first road that has vehicles moving in opposed directions with a second road that has vehicles moving in only one direction.

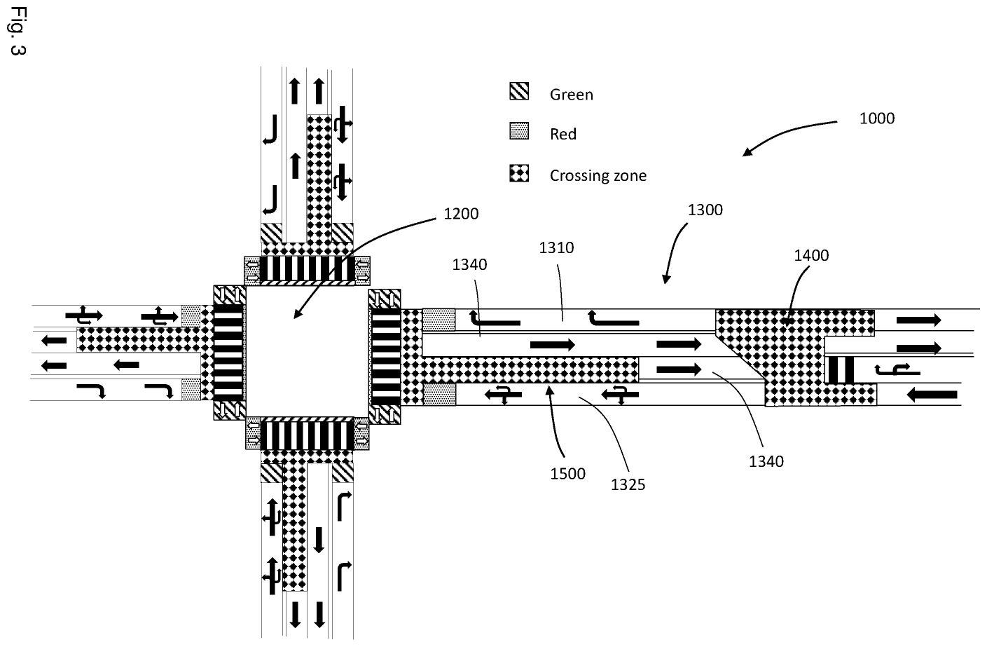

However, where the intersection is an intersection of two roads that each have vehicles moving in opposed directions, then the going straight lane 1320 may be configured to guide vehicles to turn left on to the intersecting road 1100 as a combination going straight and turning left lane 1325 as shown in FIGS. 3&4, or alternately and/or additionally, a turning left lane 1330 may be provided specifically for that purpose.

In a preferred embodiment, the proximate region 1300 further comprises one or more receiving lanes 1340 for receiving vehicles moving straight over the intersection region 1200 from an opposed side, and preferably for receiving vehicles turning left or right from the intersecting road into the proximate region 1300.

It is envisaged that the proximate region 1300 could further preferably comprise at least one or more turning left receiving lane (not shown), for receiving vehicles that have traversed through the intersection region 1200 after turning left from the intersecting road 1100, as well as at least one or more turning right receiving lane (not shown), for receiving vehicles that have traversed through the intersection region 1200 after turning right from the intersecting road 1100. However, such turning left receiving lanes and turning right receiving lanes are not preferred as they add additional lane requirements to the traffic intersection.

Importantly, the turning right lane 1310 is configured to split away from the going straight lane 1320 in the proximate region 1300 by guiding vehicles through a distal crossover zone 1400. The receiving lanes 1340 for guiding vehicles having travelled over the intersection region 1200 will guide vehicles moving away from the intersection region 1200 towards the distal crossover zone 1400. The receiving lanes 1340 also extend between the turning right lane 1310 and the going straight lane 1320, but with the vehicles moving in an opposed direction.

Vehicles travelling away from the intersection region 1200 will be guided by the receiving lane 1340 to the distal crossover zone 1400, where they will cross over the distal crossover zone 1400 to move back to the left-hand side of the road by moving at least one or more vehicles spaces to the left

It will be appreciated that, while the individual lanes have been described as if one lane is necessary for each function, this need not necessarily be the case. Where one lane can logically function, for example, as a lane for guiding cars that want to move straight as well as turn left, or as a lane for guiding cars that want to move straight as will turn right, then a single lane may be used. Examples of these are shown in the figures.

Vehicles approaching the distal crossover zone 1400 moving towards the intersection region 1200, that want to turn right into the intersecting road will be guided by visual signalling devices 3100 such as a traffic light or road markings to yield to vehicles in the receiving lanes coming from the intersection region 1200. Once it is safe, the vehicles will cross over the distal crossover zone 1400 to move over to preferably the far right lane of the multilane road.

It is further envisaged that the traffic intersection 1000 will include pedestrian crossings 2000 that are preferably configured for guiding pedestrians to traverse each of the intersecting roads on both sides of the intersection region 1200.

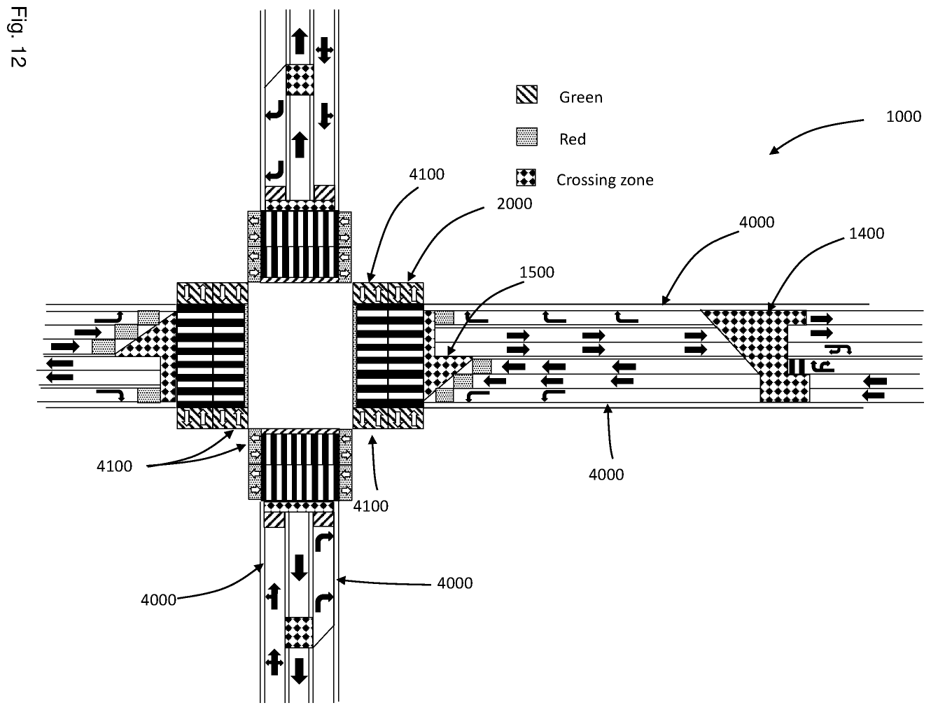

In the embodiments shown in FIG. 12, the traffic intersection 1000 further preferably comprises bicycle paths 4000 that extend along the side of each intersecting road. Further, the traffic intersection includes bicycle crossings 4100 that are preferably configured for guiding cyclists for traversing over each of the intersecting roads.

It is envisaged that the traffic intersection 1000 will be equipped with a traffic guidance system 3000 that comprises a controller 3200 that is configured for connecting to and controlling visual signalling devices 3100, preferably in the form of traffic lights. It is further envisaged that the controller can be connected to cameras 3300 configured to relay a view of the distal crossover zones 1400 and/or the intersection region 1200 and/or the proximal crossover zones 1500 to a control centre (not shown). By being able to view and record traffic in these areas, police and emergency vehicles can be dispatched quickly to ensure that the crossover zones are maintained free and free and clear of vehicles, to allow for flow of traffic even in the event of an accident or similar.

Preferably, at least one visual signalling device 3100 will be provided for each of the turning right lane, going straight lane, turning left lane, and combination going straight and turning left lane (where applicable) at each side of the intersection region 1200. The visual signalling devices 3100 can, in addition to being configured for signalling to vehicles, also be configured for signalling to pedestrians on the pedestrian crossings 2000, and cyclists on the bicycle crossings 4100.

In a preferred embodiment, the visual signalling devices 3100 will together preferably be operable in one of three configurations.

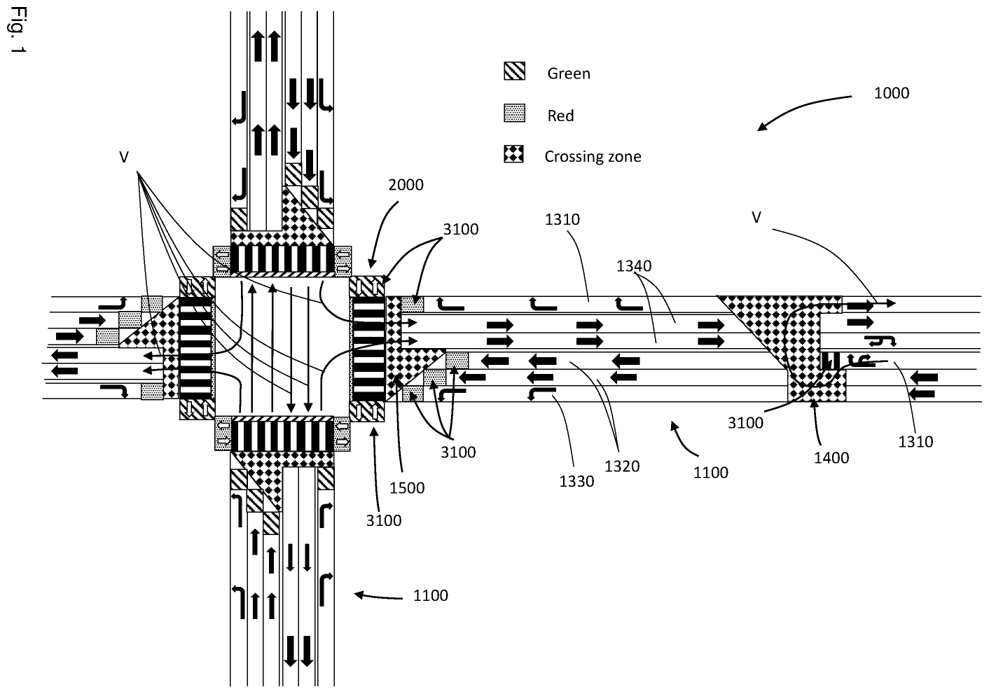

A first configuration is shown in FIG. 1, wherein vehicles on one of the intersecting roads are visually signalled by the visual signalling devices to go, while vehicles on the other of the intersecting roads are visually signalled by the visual signalling devices to stop.

At the same time, visual signalling devices 3100 signalling those pedestrian crossings 2000 that traverse the intersecting road where vehicles have been signalled to go, will signal for pedestrians crossing that road to stop. Similarly, visual signalling devices signalling those bicycle crossings 4100 that traverse the intersecting roads on which vehicles have been signalled to go, will signal for bicycles to stop.

However, visual signalling devices 3100 signalling those pedestrian crossings 2000 and bicycle crossings 4100 that traverse the intersecting road where vehicles have been signalled to stop, will signal to pedestrians and bicycles respectively to go.

A second configuration will of the visual signalling devices together will be the exact opposite of the first configuration described above, with all of the vehicles, pedestrians and bicycles that have previously been signalled to stop, then being signalled to go, and vice versa.

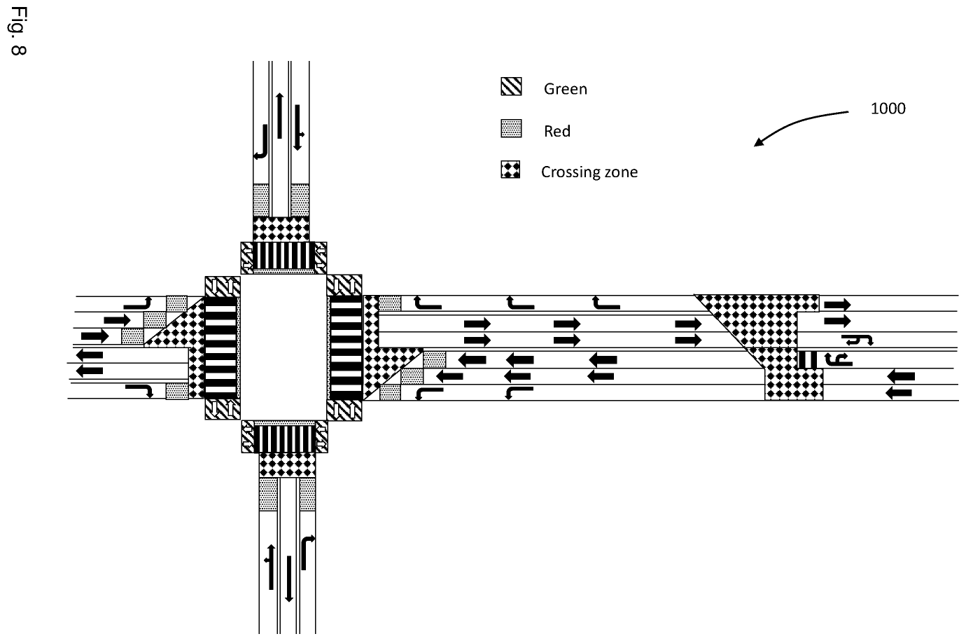

An example of a third configuration is shown in FIG. 8 without exemplifying the bicycle crossings, although it would be understood by those skilled in the art that the bicycle crossings 4100 will mirror those of the pedestrian crossings 2000. In this configuration, the visual signalling devices will signal to all of the vehicles in both of the intersecting roads to stop, while the pedestrian crossings 2000 (and bicycle crossings 4100) on both of the intersecting roads will be signalled to go.

In particular, a visual signalling device 3100 is provided for signalling to at least one turning right lane 1310 for guiding vehicles to turn right at the intersection onto the intersecting road. Further, a visual signalling device 3120 is provided for signalling to at least one going straight lane 1320 for guiding vehicles to move straight over the intersection region 1200 on the same road 1100.

For use in the traffic intersection 1000 described above, the visual signalling device 3100 for guiding vehicles in the turning right lane 1310 will preferably be distanced from the visual signalling device 3100 signalling to the going straight lane 1320 by at least two vehicle spacings, as the turning right lane 1310 will be spaced from the going straight lane 1320 by at least one lane of the receiving lane 1340.

As discussed previously, it is anticipated that a combination going straight and turning left lane 1325 can be provided be configured. Accordingly, the relevant visual signalling device 3100 can be configured to signal to vehicles to turn left onto the intersecting road 1100 as well as go straight across the intersection region 1200.

In a preferred embodiment, the controller is configured for controlling operation of the visual signalling devices 3100 to switch between their stop condition, go condition and slow condition.

The controller preferably comprises a processor (not shown) configured for receiving instructions from digital storage medium 3210, as well as digital storage media configured for storing digital instructions (not shown). The controller (not shown) is preferably connected or connectable to the visual signalling devices 3100 by means of a network 3300. The network 3300 can be a wireless network or a hardwired network.

In an alternative embodiment, it is envisaged that the controller can be remotely located, and be connected to the visual signalling devices 3100 by means of a long-distance network. The network 3300 can be the Internet, although this is not preferred.

The digital instructions preferably in the form of software that is stored on one or more digital storage mediums (not shown), such as a hard disc, a server centre, or a cloud-based storage server.

It is further envisaged that a plurality of traffic guidance systems 3000 can be controlled by a centralised controller, to thereby allow traffic to flow at more optimal levels through a plurality of traffic intersections 1000. In one embodiment, the controller comprises digital storage media for storing digital instructions, preferably in the form of an algorithm according to which the visual signalling devices 3100 are controlled.

In this way, traffic congestion caused by vehicles turning across the flow of traffic (for example in turning right lanes) is dissipated by moving area in which vehicles cross each others paths to a distance away from the intersection region 1200.

By having all of the visual signalling devices 3100 operate in two, or preferably three configurations, less time is spent by vehicles waiting for their chance to move through the intersection region 1200, while the large number of configurations that are normally encountered at a traffic intersections are cycled through. For example, if only three configurations are used, that means that in three minutes, one full minute is spent by each of the vehicles, pedestrians and bicycles moving across the intersection. In traditional traffic intersections of equivalent size, it is anticipated that five different configurations may be possible. These could include:

vehicles moving straight over the intersection (x 2 for each intersecting road)

vehicles turning left across the intersection region (x 2 for each intersecting road)

vehicles turning right across the intersection region (x2 for each intersecting road)

all vehicles on intersecting roads stopped for pedestrians crossing

For example, with five different configurations, each set of vehicles having different turning requirements would only get around 25 seconds (i.e. three minutes divided by five) to move through the intersection region. Accordingly, a traffic intersection according to the invention allows for greater flow of traffic through the intersection. Further, because only three configurations are used, this simplifies calculations when attempting to synchronise sets of visual signalling devices 3100 spaced along a single road.

In this way it is anticipated that time delays spent waiting for various turning configurations to be presented to guide vehicles turning across the flow of traffic will be reduced, allowing for increased time intervals (which means a lower proportion of time spent with vehicle standing at a halt or accelerating from a stop) and flow of traffic along the roads will be less congested.

In the embodiments shown in the figures, the turning right lanes 1310 and the turning left lanes 1330 preferably guide the vehicles to be received into receiving lanes 1340 that also function as receiving lanes for vehicles going straight across the intersection on the other of the intersecting roads 1100 when the visual signalling devices 3100 are in a different configuration. The passing of the vehicles are generally shown in the figures as reference arrows V.

Further, the turning left lane 1330 is also configured forguiding vehicles to turn from the turning left lane of one of the intersecting road into a receiving lane 1340 on the other of the intersecting roads.

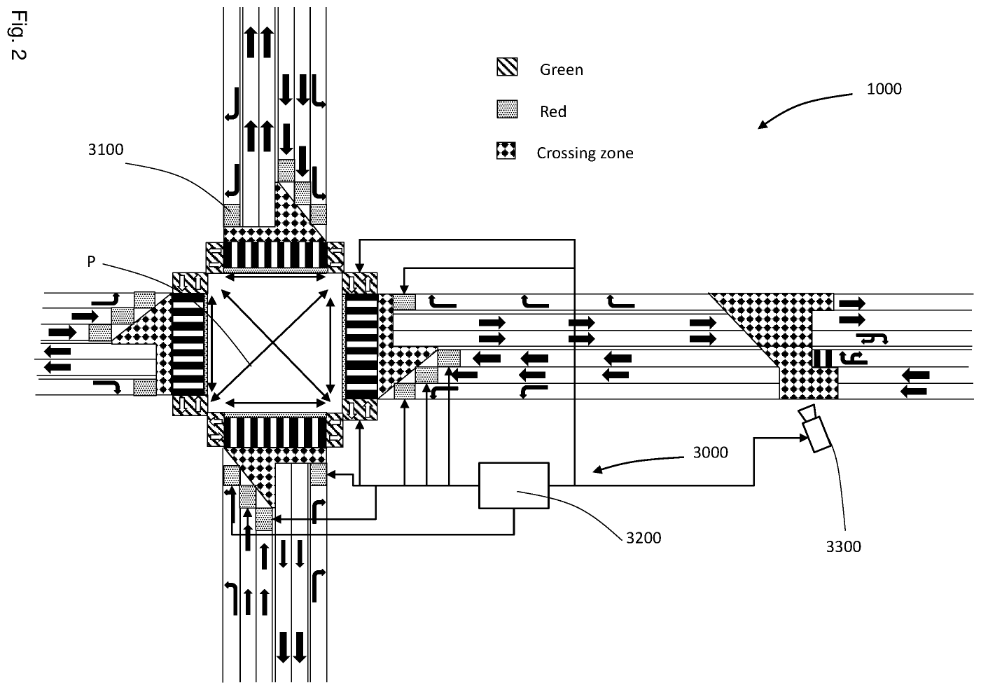

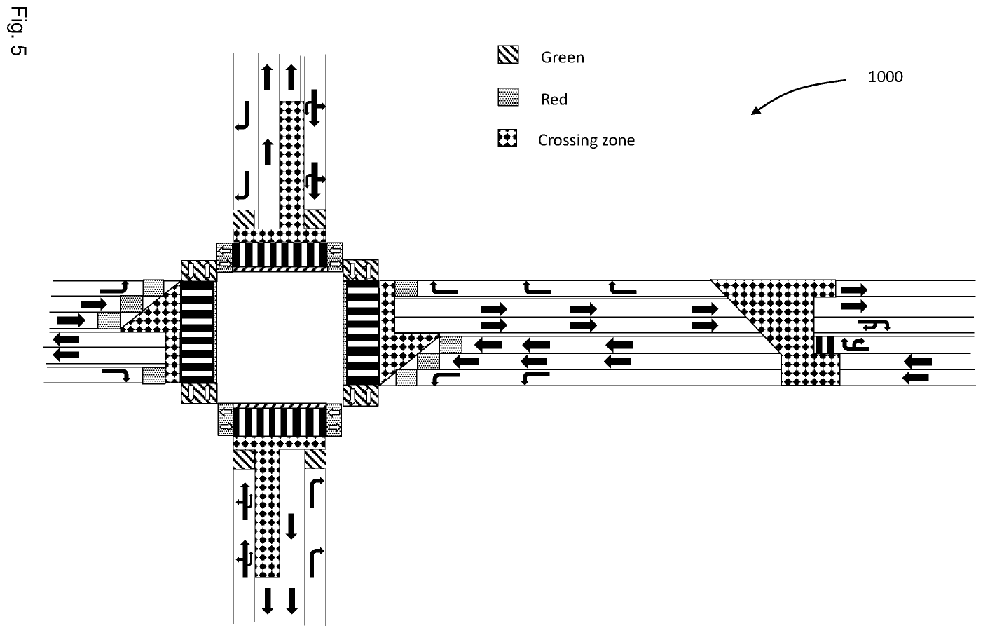

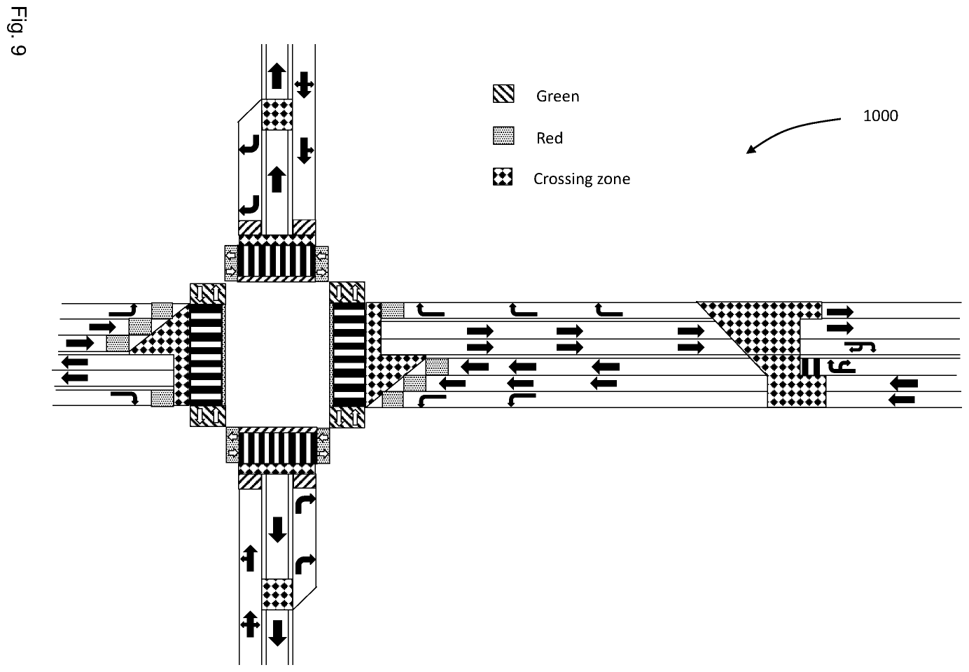

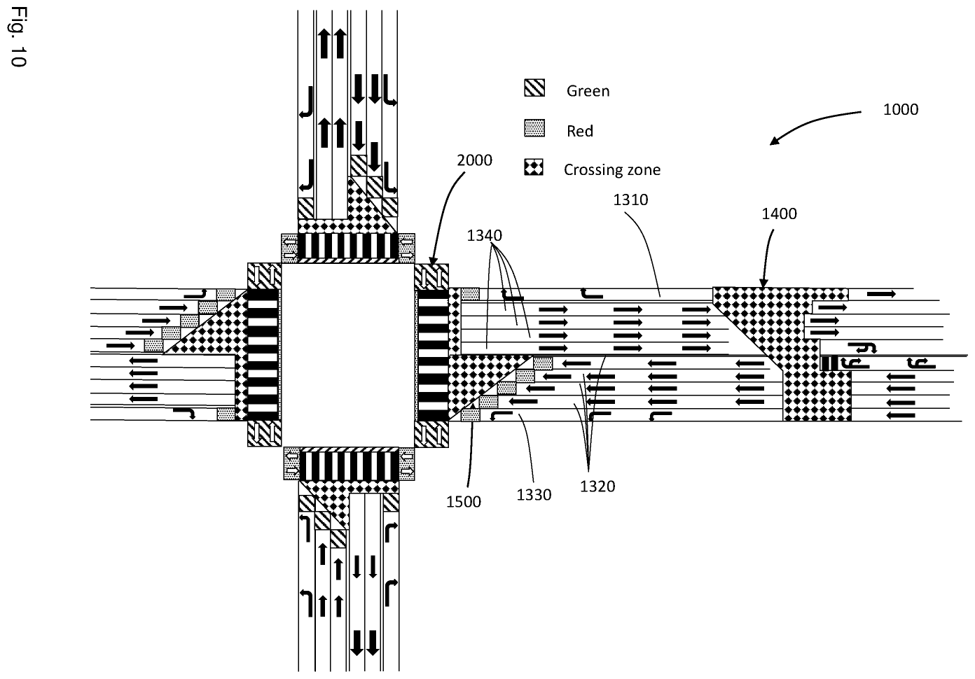

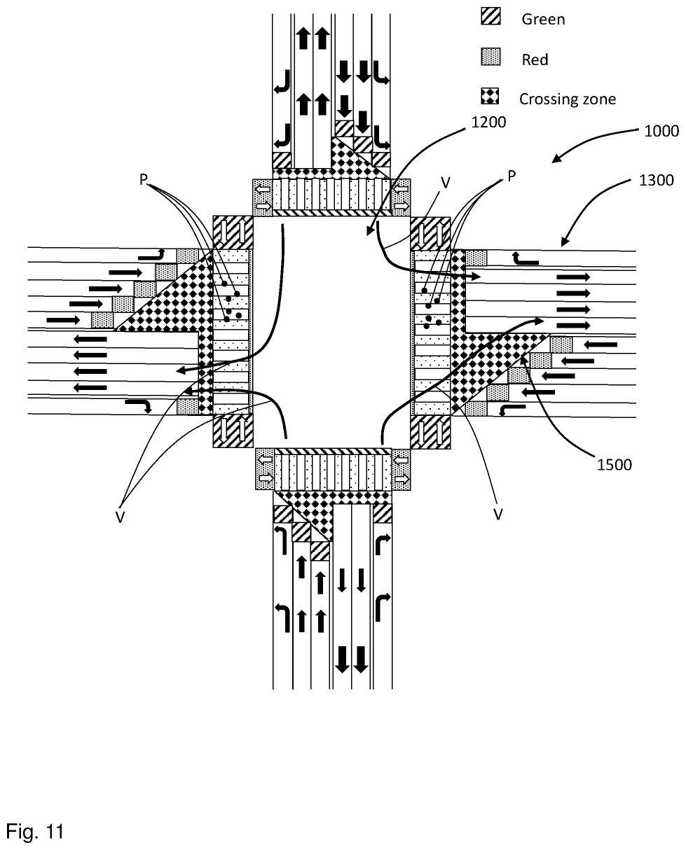

As shown in FIGS. 1, 2, 5, 8, 9, 10, 11 and 12, the turning left lane 1330 and the going straight lanes 1320 are configured to terminate adjacent the intersection region 1200 in a staggered fashion, leaving space for a triangularly shaped proximal crossover zone 1500 that is disposed adjacent the intersection region 1200. The proximal crossover zone is configured for allowing vehicles turning from a turning right lane 1310 or a turning left lane 1330 in the intersecting road into the receiving lanes 1340 of the other intersecting road, a variety of paths to path around pedestrians that are crossing the road that the proximal crossover zone 1500 is in. The passing of a vehicle is shown in FIG. 11 by reference arrows V, and pedestrians crossing the road shown as black dots P.

In the embodiments shown in FIG. 3, where a four lane road intersects with another road, then typically a combination going straight and turning left lane 1325 is provided as the leftmost lane approaching the intersection region 1200. The proximal crossover zone 1500 in this figure is disposed adjacent the combination turning left and going straight lane. The proximal crossover zone 1500 is configured to receive vehicles that are moving straight through the intersection, and moving over from the combination going straight and turning left lane 1305, to thereby allow vehicles moving straight through the intersection to pass vehicles that are turning left from the combination turning left and going straight lane. Vehicles turning left are received into the receiving leftmost receiving lane 1340, while vehicles turning right I received into the right most receiving lane 1340. Vehicles moving straight across the intersection move from the proximal crossover zone 1500 to be received into the leftmost receiving lane (which would not be in use by vehicles turning from the intersecting road as their visual signalling devices 3100 would be signalling for them to stop.

It is envisaged that the proximal crossover zone 1500 could be used for multilane roads 1100 having more than four lanes, however in such cases, there would be separate lands provided for going straight and turning left, and such a requirement would be moot. For multilane roads 1100 having three lanes, there would not be sufficient space for a proximal crossover zone 1500 having a function as described.

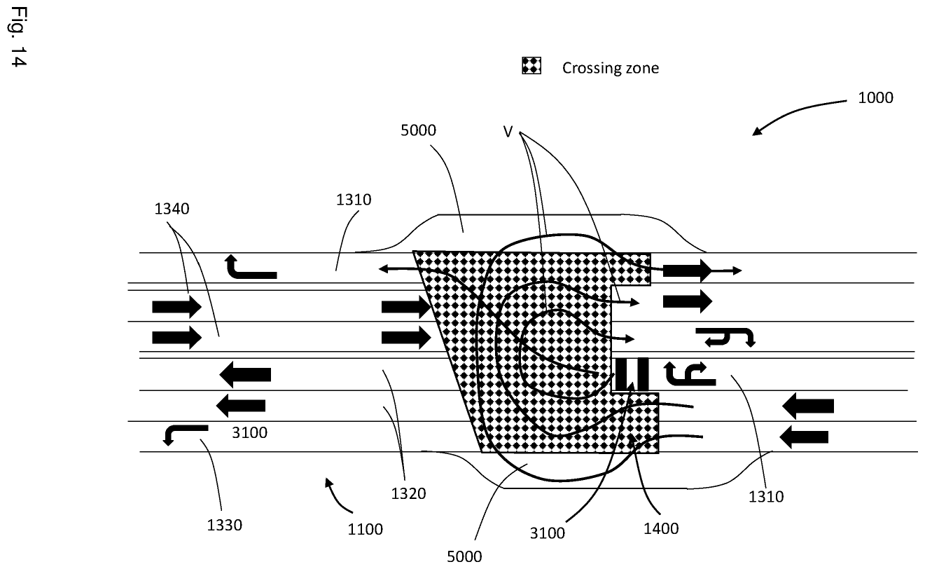

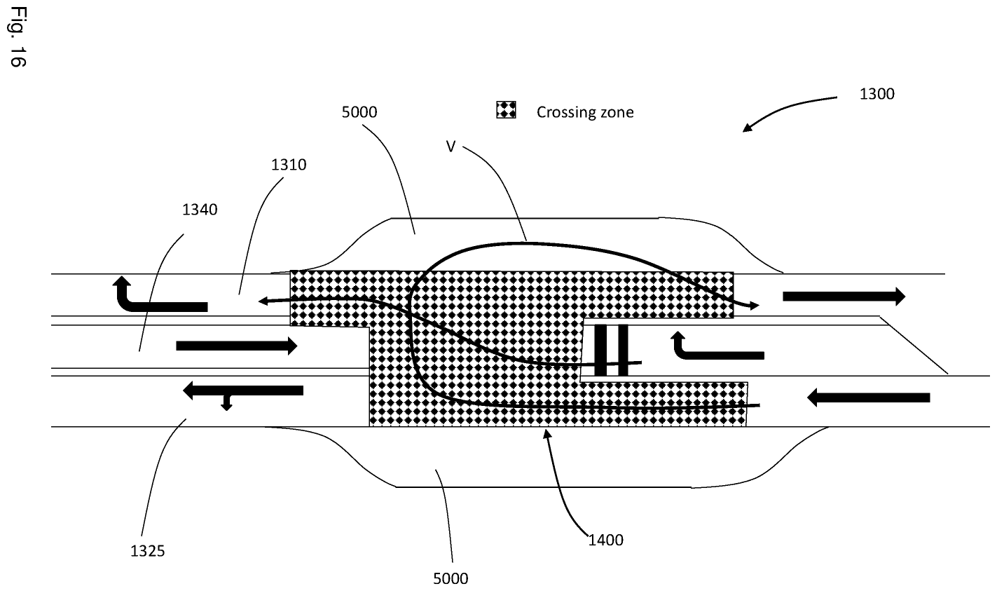

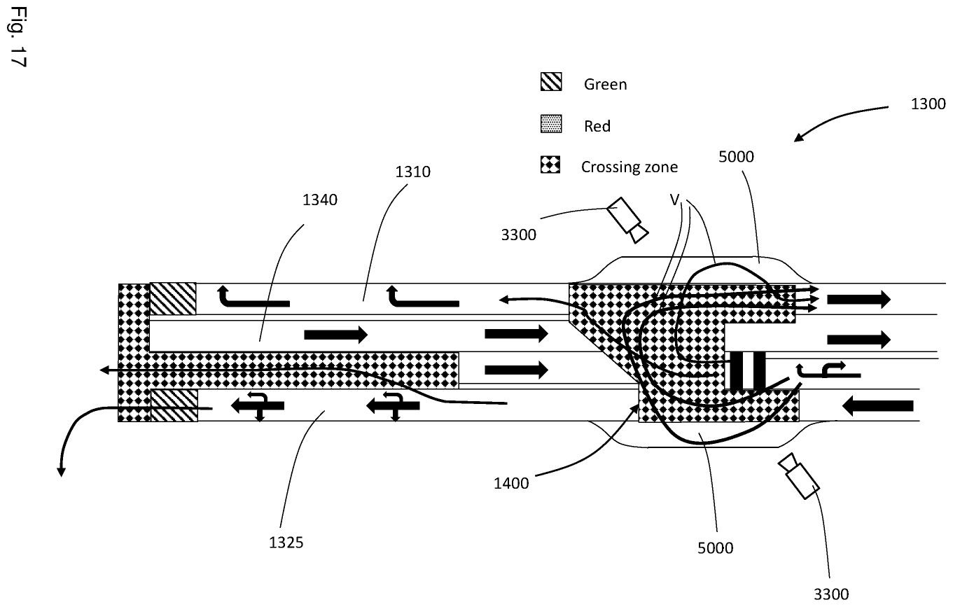

As shown in the figures, the distal crossover zone 1400 is preferably configured for guiding vehicles, and especially large vehicles, to do a U-turn, for example by extending over the full width of the road 1100. Vehicles can then move from the turning right lane distal to the distal crossover zone 1400, into the distal crossover zone 1400 to do a U-turn. Example of vehicles carrying a U-turn is shown in FIGS. 1, 14, 16 and 17 by reference arrow V. It is further envisaged that, by optionally providing one or more bus stop bays 5000 to either side of the distal crossover zone, this will facilitate allowing vehicles, and especially longer vehicles, to carry out U-turns on the road 1100. As shown in FIGS. 16 and 17, the bus stop bay 5000 on at least the right-hand side of the road is preferred as this allows for vehicles to carry out U-turns from the right hand turn lane.

Where, for example a traffic accident or other emergency has happened at or close to the intersection region 1200, it is envisaged that the traffic intersection 1000 will still allow for vehicles to turn right or left, thereby preventing a complete halt in traffic. Where an emergency situation or similar has caused traffic flow to come to a halt completely in the intersection region 1200, it is envisaged that vehicles distal crossover zone 1400 to carry out U-turns will allow for flow towards and away from the proximal zone. Such traffic flow could, for example be used by emergency services to allow emergency services vehicles to get closer to the congested traffic intersection, and also allow the traffic intersection to be cleared faster.

It is further envisaged that where bus stop bays 5000 are provided next to the distal crossover zone 1400, buses will be provided with a space in which to move out into the road.

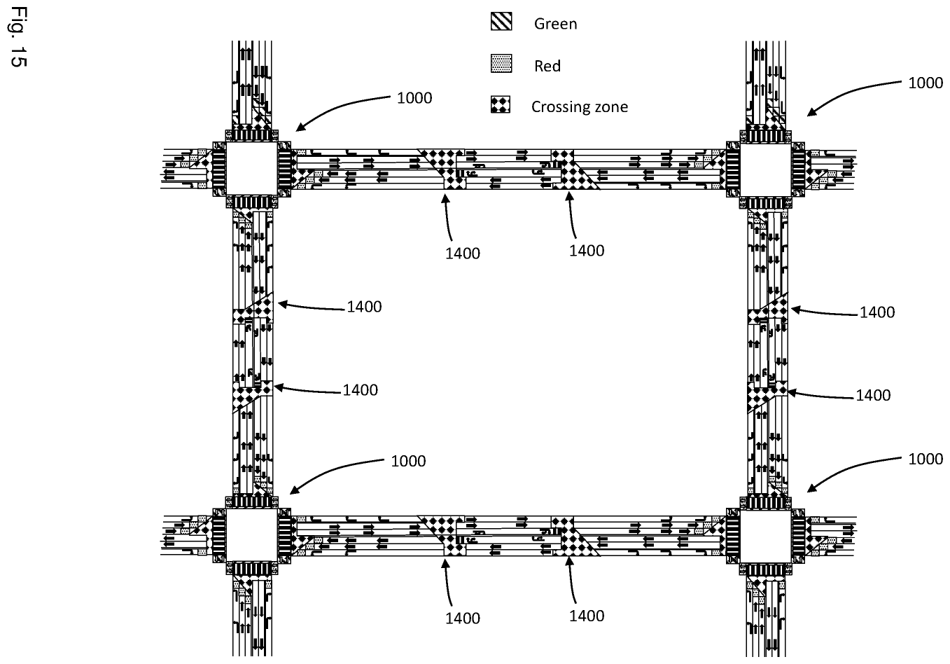

In this way, and with reference to FIG. 15, it will be appreciated by those skilled in the art that the distal crossover zone is 1400 can be used in a larger grid of traffic intersections 1000 to divert traffic away from a fouled up intersection region 1200.

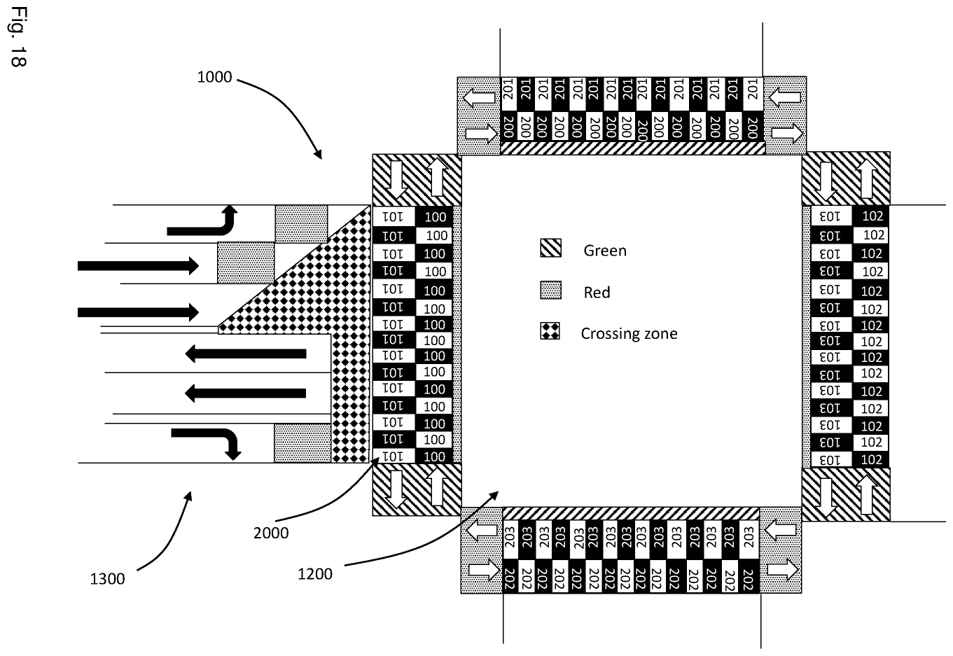

It is further envisaged that any part of the traffic intersection can be marked to display one or more selected from the street numbers, the direction of increase or decrease of street numbers, or the direction of alignment of the road. In the embodiment shown in FIG. 18, the pedestrian crossings are be marked to display the street number to which the pedestrians are walking.

In another embodiment, it is envisaged that the directional arrows of the road markings can be colour-coded to correspond to the compass directions in which the vehicles being directed to.

It will be appreciated by those skilled in the art that any number of configurations of such markings are possible.

### Interpretation

In accordance with:

As described herein, :in accordance with ^{\check{}}may also mean :as a function of ^{\check{}}and is not necessarily limited to the integers specified in relation thereto.

### Database:

In the context of this document, the term database and its derivatives may be used to describe a single database, a set of databases, a system of databases or the like. The system of databases may comprise a set of databases wherein the set of databases may be stored on a single implementation or span across multiple implementations. The term database is also not limited to refer to a certain database format rather may refer to any database format For example, database formats may include MySQL, MySQLi, XML or the like.

### Wireless:

The invention may be embodied using devices conforming to other network standards and for other applications, including, for example other WLAN standards and other wireless standards. Applications that can be accommodated include IEEE 802.11 wireless LANs and links, and wireless Ethernet

In the context of this document, the term wireless and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term wired and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes:

Unless specifically stated otherwise, as apparent from the following discussions, it is appreciated that throughout the specification discussions utilizing terms such as processing, computing, calculating, determining, analysing or the like, refer to the action and/or processes of a computer or computing system, or similar electronic computing device, that manipulate and/or transform data represented as physical, such as electronic, quantities into other data similarly represented as physical quantities.

### Processor:

In a similar manner, the term processor may refer to any device or portion of a device that processes electronic data, e.g., from registers and/or memory to transform that electronic data into other electronic data that, e.g., may be stored in registers and/or memory. A computer or a computing device or a computing machine or a computing platform may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect For example, while only a single machine is illustrated, the term ‘machine_shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium:

The software may further be transmitted or received over a network via a network interface device. While the carrier medium is shown in an example embodiment to be a single medium, the term carrier medium should be taken to include a single medium or multiple media (e.g., a centralized or distributed database, and/or associated caches and servers) that store the one or more sets of instructions. The term ‘carrier medium_{—} shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means For Carrying Out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. Connected may mean that two or more elements are either in direct physical or electrical contact, or that two or more elements are not in direct contact with each other but yet still co-operate or interact with each other.

### Embodiments

Reference throughout this specification to one embodiment or an embodiment means that a particular feature, structure or characteristic described in connection with the embodiment is included in at least one embodiment of the present invention. Thus, appearances of the phrases in one embodiment or in an embodiment in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as forward, rearward, radially, peripherally, upwardly, downwardly, and the like are used as words of convenience to provide reference points and are not to be construed as limiting terms.

### Different Instances of Objects

As used herein, unless otherwise specified the use of the ordinal adjectives first, second, third, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word comprise or variations such as comprises or comprising are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Chronological Order

For the purpose of this specification, where method steps are described in sequence, the sequence does not necessarily mean that the steps are to be carried out in chronological order in that sequence, unless there is no other logical manner of interpreting the sequence.

### Markush Groups

In addition, where features or aspects of the invention are described in terms of Markush groups, those skilled in the art will recognise that the invention is also thereby described in terms of any individual member or subgroup of members of the Markush group.

### INDUSTRIAL APPLICABILITY

It is apparent from the above, that the arrangements described are applicable to the traffic management industries.

1-55. (canceled)

56. A traffic intersection located at an intersection of two multilane roads, each road comprising a plurality of traffic lanes spaced adjacent each other, the traffic intersection comprising:
a. an intersection region wherein the surface area of the intersecting roads overlap;
b. a proximate region in which at least one road approaching the intersection defines:
i. at least one turning right lane for guiding vehicles to turn right at the intersection onto the intersecting road;
ii. at least one going straight lane for guiding vehicles to move straight through the intersection on the same road; and
iii. a plurality of going straight receiving lane for receiving vehicles moving straight through the intersection;
c. wherein the turning right lane is configured to split from the going straight lane in the proximate region by crossing through a distal crossover zone, so that vehicles travelling straight through the intersection in an opposite direction along the same road are guided to move between the turning right lane and the going straight lane in the going straight receiving lane; and
d. wherein the going straight lanes are configured for guiding vehicles over the intersection to at least one or more going straight receiving lanes at an opposed side of the intersection; and
e. wherein the turning right lane is configured for guiding vehicles to turn from the turning right lane of one of the intersecting roads into a receiving straight lane on the other of the intersecting roads;
f. wherein the traffic intersection defines pedestrian crossings configured for guiding pedestrians across at least one of the intersecting roads, and the plurality of going straight lanes terminate in a staggered fashion adjacent the intersection region, to define a proximal crossover zone ahead of the terminations of the going straight lanes, the proximal crossover zone being configured for allowing vehicles turning from a turning right lane into the intersecting road a variety of pathing routes past pedestrians that are crossing the road that the proximal crossover zone is in.

57. A traffic intersection as claimed in claim 56, wherein the going straight lanes are configured for guiding vehicles over the intersection in a straight line to the said at least one or more going straight receiving lanes.

58. A traffic intersection as claimed in claim 56, wherein the proximate region further comprises at least one turning left lane, the at least one turning left lane configured for guiding vehicles to turn left at the intersection onto the intersecting road.

59. A traffic intersection as claimed in claim 58, wherein the turning left lane is configured for guiding vehicles to turn from the turning left lane of one of the intersecting road into a going straight receiving lane on the other of the intersecting roads.

60. A traffic intersection as claimed in claim 58, wherein at least one or more selected from the turning left lane and the going straight lanes are configured to terminate in a staggered fashion adjacent the intersection region to thereby allow space for a proximal crossover zone.

61. A traffic intersection as claimed in claim 60, wherein the proximate region includes a combination turning left and going straight lane and the proximal crossover zone is disposed adjacent the combination turning left and going straight lane, and is configured to receive vehicles that are moving straight through the intersection, thereby allowing the vehicles moving straight through the intersection to pass vehicles that are turning left from the combination turning left and going straight lane.

62. A traffic intersection as claimed in claim 60, wherein the road with the proximal crossover zone is a four-lane road.

63. A traffic intersection as claimed in claim 62, wherein in the proximate region of the four-lane road, the road defines a combination turning left and going straight lane, a going straight receiving lane and a turning right lane, wherein the turning right lane is disposed two lane widths apart from the combination turning left and going straight lane, and the proximal crossover zone is disposed adjacent the combination turning left and going straight lane, and is configured to receive vehicles that are moving straight through the intersection, thereby allowing the vehicles moving straight through the intersection to pass vehicles that are turning left from the combination turning left and going straight lane.

64. A traffic intersection as claimed in claim 56, wherein at least one intersecting road defines a right turning lane distal of the distal crossover zone, and is configured for guiding vehicles to give way to vehicles crossing over the distal crossover zone from the at least one or more going straight receiving lanes.

65. A traffic intersection located at an intersection of two multilane roads, each road comprising a plurality of traffic lanes spaced adjacent each other, the traffic intersection comprising:
a. an intersection region wherein the surface area of the intersecting roads overlap;
b. a proximate region in which at least one of the roads approaching the intersection defines:
i. at least one turning right lane for guiding vehicles to turn right at the intersection onto the intersecting road;
ii. at least one combination going straight and turning left lane for guiding vehicles to move straight through the intersection and to turn left at the intersection;
c. wherein the turning right lane is configured to split from the going straight lane in the proximate region by crossing through a distal crossover zone, so that vehicles travelling straight through the intersection in an opposite direction along the same road are guided to move in an opposed direction between the turning right lane and the combination going straight and turning left lane in a going straight receiving lane; and
d. wherein the traffic intersection defines a proximal crossover zone disposed adjacent the combination turning left and going straight lane, and is configured to receive vehicles that are moving straight through the intersection, thereby allowing the vehicles moving straight through the intersection to pass vehicles that are turning left from the combination turning left and going straight lane.

66. A traffic intersection as claimed in claim 65, wherein the road with the proximal crossover zone is a four-lane road.

67. A traffic intersection as claimed in claim 65, wherein at least one or more selected from the turning left lanes and the going straight lanes are configured to terminate in a staggered fashion adjacent the intersection region to thereby allow space for the proximal crossover zone.

68. A traffic intersection as claimed in claim 65, wherein at least one of the intersecting roads comprises a plurality of going straight lanes that terminate in a staggered fashion adjacent the intersection region, to thereby allow space for a proximal crossover zone, the proximal crossover zone being configured for allowing vehicles turning from a turning right lane in the intersecting road a variety of pathing routes past pedestrians that are crossing the road that the proximal crossover zone is in.

69. A traffic intersection located at an intersection of two multilane roads, each road comprising a plurality of traffic lanes spaced adjacent each other, the traffic intersection comprising:
a. an intersection region wherein the surface area of the intersecting roads overlap;
b. a proximate region in which each road approaching the intersection defines:
i. at least one turning right lane for guiding vehicles to turn right at the intersection onto the intersecting road;
ii. at least one turning left lane configured for guiding vehicles to turn left at the intersection onto the intersecting road;
iii. a plurality of going straight lane for guiding vehicles to move straight through the intersection on the same road;
c. wherein the turning right lane is configured to split from the going straight lane in the proximate region by crossing through a distal crossover zone, so that vehicles travelling straight through the intersection in an opposite direction along the same road are guided to move between the turning right lane and the going straight lane; and
d. wherein the plurality of going straight lanes terminate in a staggered fashion adjacent the intersection region, and to thereby allow space for a proximal crossover zone, the proximal crossover zone being configured for allowing vehicles turning from a turning right lane in the intersecting road a variety of pathing routes past pedestrians that are crossing the road that the proximal crossover zone is in.

70. A traffic intersection as claimed in claim 69, wherein the turning right lane is configured to split from the going straight lane in the proximate region by crossing through a distal crossover zone, so that vehicles travelling straight through the intersection in an opposite direction along the same road are guided to move between the turning right lane and the going straight lane.

71. A traffic intersection as claimed in claim 69, wherein the proximal crossover zone is disposed adjacent the combination turning left and going straight lane, and is configured to receive vehicles that are moving straight through the intersection, thereby allowing the vehicles moving straight through the intersection to pass vehicles that are turning left from the combination turning left and going straight lane.

72. A traffic intersection as claimed in claim 69, wherein the road with the proximal crossover zone is a four-lane road.
